(19) United States
(12) Patent Application Publication
(10) Pub. No.: US 2014/0050488 A1
(43) Pub. Date: Feb. 20, 2014

(54) COMMUNICATION SYSTEM FOR POWER ELECTRONIC CONVERTERS

(71) Applicant: ABB RESEARCH LTD, Zurich (CH)

(72) Inventors: Dacfey Dzung, Wettingen (CH); Didier Cottet, Zurich (CH); Anne Vallestad, Sandvika (NO); Lars Kalland, Haslum (NO)

(73) Assignee: ABB RESEARCH LTD, Zurich (CH)

(21) Appl. No.: 14/057,628

(22) Filed: Oct. 18, 2013

Related U.S. Application Data
(63) Continuation of application No. PCT/EP2012/055625, filed on Mar. 26, 2012.

(30) Foreign Application Priority Data
Apr. 19, 2011 (EP) 11163066.1

(51) Int. Cl. H04B 10/11

(52) U.S. Cl. CPC H04B 10/11
USPC 398/130

(57) ABSTRACT

Exemplary embodiments of a communication system for a power electronic converter with a plurality of converter modules includes controllable power semiconductor switches and individually mountable onto a converter cabinet or frame. The communication system includes unguided transmission of optical signals between optical elements arranged on a converter module and on the converter cabinet, respectively. The communication system provides a free-space optical signal transmission between two distinct parts of the converter that combines the flexibility offered by radio transmission and the data rate and reliability of optical communication, while at the same time avoiding the complex and expensive cabling of optical fiber solutions.

### RELATED APPLICATION(S)

This application claims priority under 35 U.S.C. §119 to International application PCT/EP2012/055625 filed on Mar. 29, 2012, designating the U.S., and claiming priority to European application 11163066.1 filed in Europe on Apr. 19, 2011. The content of each prior application is hereby incorporated by reference in its entirety.

### FIELD

The disclosure relates to the field of power electronic converters, and for example to a communication system for controlling or supervising at least one power semiconductor switch of the converter.

### BACKGROUND INFORMATION

Known power electronic converters can be widely used for converting electric power from AC (alternating current) to DC (direct current), from DC to AC, from a first DC voltage to a second DC voltage, or from a first AC frequency to a second AC frequency. The converters can include a plurality of possibly identical converter modules arranged in a converter cabinet or housing and in turn including power semiconductor switches or valves such as IGCTs (integrated gate-commutated thyristors) or IGBTs (insulated gate bipolar transistors) and their corresponding control units or drivers. Depending on the intended field of application, the modules can be on medium to high electric potential in excess of 1 kV, and ranging up to 30 kV, for example, with respect to ground potential. Communication lines for communicating switching commands from a higher level converter control unit on ground potential should electrically isolate or bridge this potential difference.

In known implementations, communication signals in this context can be carried by optical fibers which can support high-data rates and can be capable of withstanding large voltages, albeit at the expense of a substantial ageing behavior. This solution however can include mechanical connectors at both ends of the optical fiber, which renders the mounting and replacement of the converter modules cumbersome, and which adds to the costs of the mechanical connectors to the costs of the fiber. DE-102004004621-A1 addresses this issue by proposing to rigidly mount a piece of optical fibre on an electro-optical circuit board, and to couple the optical signal via lenses and mirrors. The intra-board isolation achieved this way appears to work fine for voltages of up to 500 V.

### SUMMARY

An exemplary communication system for a power electronic converter with a plurality of converter modules individually mountable in a converter cabinet is disclosed, comprising: a first optical element and a second optical element that propagate an optical signal to or from the respective other optical element, the first and second optical elements being arranged respectively on the converter cabinet and on a converter module, and an optically transparent medium including a straight optical path between the first optical element and the second optical element.

An exemplary converter module for a power electronic converter with a plurality of converter modules individually mountable in a converter cabinet is disclosed, the converter module comprising: a power semiconductor switch; a communication unit; and a second optical element that propagates to the communication unit, an optical signal received from a first optical element arranged on a converter cabinet, the optical signal being propagated across an optically transparent medium, wherein the optically transparent medium includes a straight optical path between the first optical element and the second optical element.

### BRIEF DESCRIPTION OF THE DRAWINGS

The subject matter of the disclosure will be explained in more detail in the following text with reference to preferred exemplary embodiments which can be illustrated in the attached drawings, in which:

FIG. 1 shows a power electronic converter with two cabinets according to an exemplary embodiment of the disclosure;

FIG. 2 shows an enlarged view of a module-transceiver pair according to an exemplary embodiment of the disclosure; and

FIG. 3 shows an optical path with mechanical protection according to an exemplary embodiment of the disclosure.

In principle, identical parts can be provided with the same reference symbols in the figures.

### DETAILED DESCRIPTION

Exemplary embodiments of the disclosure enable a flexible and cost-effective electrical isolation between communicating converter parts on different electrical potential.

According to an exemplary embodiment of the disclosure, a power electronic converter with a plurality of converter modules including controllable power semiconductor switches and individually mountable onto a converter cabinet or frame has a communication system that involves unguided transmission of optical signals between optical elements arranged on a converter module and on the converter cabinet, respectively. The free-space optical signal transmission between two distinct parts of the converter combines advantages in terms of flexibility offered by radio transmission and advantages of optical communication in terms of data rate, reliability, and electromagnetic immunity, while at the same time avoiding the complex and expensive cabling of optical fiber solutions.

An exemplary first optical element such as a transceiver cover of a photoelectric transceiver, a mirror, or a lens is arranged on a suitable support such as a Printed Circuit Board mounted onto the converter cabinet. A second optical element is arranged on a different support that is part of the converter module. The first and second optical elements can be adapted to propagate an optical, e.g., a visible, Infrared (IR), or Ultraviolet (UV) signal from or to a respective transceiver. Between the first and second optical element, a straight optical path along a line-of-sight is defined and traversing an optically transparent medium including, for example, air or glass. The straight optical path does not involve reflection or other guidance of the optical signal at lateral boundaries of the optically transparent medium.

In an exemplary embodiment of the present disclosure, the straight optical path is adapted or designed to isolate or withstand a potential or voltage difference between the converter cabinet on ground potential and the converter module at a potential in excess of 1 kV, or even in excess of 3 kV, for example.

According to another exemplary embodiment, the optical transmission path is shielded against non-transparent particles or other obscurities. Compared to radio transmission, the possibility to selectively guide and shield the optical transmission paths allows to further increase data rate and transmission reliability.

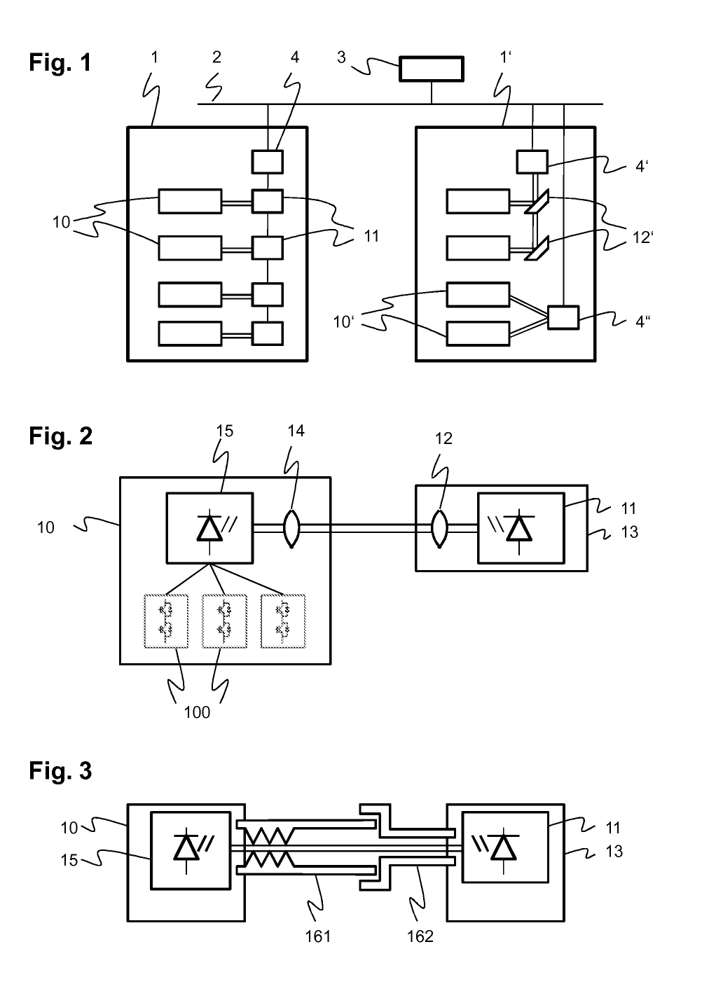

FIG. 1 shows a power electronic converter with two cabinets according to an exemplary embodiment of the disclosure. FIG. 1 illustrates an exemplary embodiment in which a power electronic converter with two cabinets 1, 1′, in each of which a plurality of converter modules 10 can be mounted. The converter modules include power electronic semiconductor switches or valves that can be adapted to switch large currents flowing in power conductors (not shown) from or to the converter. In the context of the present disclosure, the term cabinet designates a separable part of the converter with a supporting frame and a dedicated cabinet housing and power supply. A wired backbone network 2 carries communication signals between a higher level converter controller 3 and cabinet controllers 4, 4′, 4″. In the left-hand cabinet 1, the cabinet controller 4 is connected to a number of electro-optical transceivers 11 that can be in turn mounted on or attached to the cabinet housing. Based on the communication signals from the converter controller 3 or cabinet controller 4, each of the transceivers 11 generates optical signals that can be transmitted to an associated one of the plurality of power electronic modules 10. In the right-hand cabinet 1′, the two cabinet controllers 4′, 4″ incorporate electro-optical transceivers that generate and address optical signals at the attention of the modules 10′ in the cabinet 1′. These signals can be propagated in a point-to-multipoint manner to a plurality of modules in parallel. This occurs either by means of appropriate passive first optical elements 12′ such as beam splitters or mirrors redirecting the optical signals as specified, or by reverting to diffuse propagation in case of an electro-optical transceiver devoid of any focusing or other beam-generating element.

FIG. 2 shows an enlarged view of a module-transceiver pair according to an exemplary embodiment of the disclosure. The electro-optical transceiver 11 generates the optical data signals by modulating the output of lasers or light emitting diodes. A first optical element 12 such as a transparent enclosure or cover of the photoelectric transceiver, a standalone mirror, or a standalone lens is arranged on a suitable support 13 such as a Printed Circuit Board mounted onto the converter cabinet. The optical signal is collected by a second optical element 14 and detected by a photodiode as part of a communication unit 15 of the module. Again, the second optical element 14 can be a transparent enclosure or cover of the photodiode or of the communication unit 15, or a standalone mirror or lens suitably arranged on the module 10. Hence, in one exemplary embodiment, the optical elements 12 and 14 can be an integral part of the electro-optical transceiver 11 and the communicating unit 15, respectively, and in another exemplary embodiment be an external part of these same components. The photodiode converts the received optical signal into an electrical signal, based on which a module controller issues control commands to the individual power semiconductor switches 100 of the module 10. The distance between the first 12 and second 14 optical element, e.g., the length of the optical path can lie between 5 cm and 2 m, for example. It shall be understood that in the arrangement of cabinet 2 of FIG. 1, the support by means of which a first optical element, e.g., a mirror 12′, is attached to the cabinet 1′ can be different from a support of the unique electro-optical transceiver.

In FIGS. 1 and 2, the point-to-point and point-to-multipoint optical paths can be represented by double lines, wherein a voltage difference between the converter cabinet and the converter module is entirely absorbed between the two optical elements 12, 14. The first optical elements 12, 12′ can be mechanically fixed to the cabinet 1, 1′ in a manner independent of the mounting of the modules 10, 10′ (carrying the second optical element 14) in the same cabinet. Hence, and provided that the two optical elements can be properly aligned, there is no separate manual step such as (dis-)connecting a mechanical connector that would have to be observed specifically for communication purposes when mounting and dismounting the modules. Proper alignment of the optical elements can be arranged for by means of a slide-in mounting mechanism for fast assembly and servicing of the converter modules.

The optical signal propagates between the two optical elements in a straight line, e.g., the optical signal is not reflected or redirected by a further mirror or at the transition between two distinct media such as the surface of an optical fiber. Hence, optical signal propagation can occur in a directed light beam, although diffuse optical signal propagation is also possible as long as a sufficient share of the emitted light is collected by the second optical element. Optical mirrors can be used to guide the optical signals around corners within the converter module 10 or on the support 13, if specified by the mechanical design of the converter cabinet and modules.

The proposed optical communication can take place bi-directionally, e.g., in addition to the top-down communication of control commands to the power semiconductor switches, sensing, supervisory or other diagnostic signals can be communicated from the modules to the higher level converter controller. To this purpose, electro-optical transceivers can be likewise provided on the module, while the counterpart support mounted on the cabinet likewise includes an opto-electronic detector or photodiode. For added reliability, redundant bi-directional links can be implemented.

The wired backbone network carrying the communication signals to the physical locations of the electro-optical transceivers inside converter cabinets can be modular and thus allows adding or removing an optical link in a modular way such as to accommodate a definable number of links in each cabinet.

Optical communication in free space can be impaired by solid particles such as dust from the environment or other optically non-transparent media, and by particles emanating from the equipment such a smoke, as well as by external light sources, for example arcs. Therefore, the optical propagation paths can be protected by a shield or tube.

FIG. 3 shows an optical path with mechanical protection according to an exemplary embodiment of the disclosure. FIG. 3 illustrates an exemplary embodiment in which an electro-optical transceiver 11 and a communicating unit 15 arranged respectively on a converter module 10 and a support 13, as well as a shield 16 for mechanical protection of the optical path. The shield has the form of a thin-walled tube arranged in between the module and support. For example, the shield includes two parts, a first part 161 attached to the module 10, and a second part 162 attached to the support 13, which engage in a suitable fitting. The first part 161 has a surface shape in the form of ripples that provide for a definable creepage distance for high voltage insulation.

According to an exemplary embodiment disclosed herein, any solid material, for example a volume of epoxy, providing electrical insulation between the converter cabinet and the converter modules and therefore extending substantially in a direction perpendicular to the optical path, can contain openings or holes through which the optical beams do propagate. In any case, optimal protection of the optical link can be realized even if only a small air gap remains between transceiver and communicating unit and a respective end of the shield or of the opening. Bi-directional transmission and redundant paths can occur either through separate shields or openings, or in a common shield or opening.

The proposed free-space optical signal transmission is also possible as direct inter-module communication between two neighbouring converter modules.

In summary, according to an exemplary embodiment of the present disclosure providing free-space signal transmission, the optical signal, when coding control information directed to a power semiconductor switch of the converter module, can be generated by an emitter connected to a central converter control unit of the power electronic converter and detected by a detector connected to a controller of the power semiconductor switch. In another exemplary embodiment, the optical signal, when coding diagnostic information from the power semiconductor switch, can be generated by an emitter connected to a controller of the power semiconductor switch, and detected by a detector connected to the converter control unit.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 converter cabinet

2 backbone network

3 converter controller

4 cabinet controller

10 converter module

11 electro-optical transceiver

12 first optical element

13 support

14 second optical element

15 communication unit

100 power semiconductor

161, 162 shield

What is claimed is:

1. A communication system for a power electronic converter with a plurality of converter modules individually mountable in a converter cabinet, comprising:
a first optical element and a second optical element that propagate an optical signal to or from the respective other optical element, the first and second optical elements being arranged respectively on the converter cabinet and on a converter module, and
an optically transparent medium including a straight optical path between the first optical element and the second optical element.

2. The communication system according to claim 1, wherein the straight optical path isolates a potential difference in excess of 1 kV, between the converter cabinet and the converter module.

3. The communication system according to claim 2, wherein the straight optical path isolates a potential difference in excess of 3 kV.

4. The communication system according to claim 1, wherein the transparent optical medium is air and a shield protects the straight optical path against non-transparent obstacles.

5. The communication system according to claim 2, wherein the optically transparent medium is air, and the straight optical path passes through openings in a solid electrical isolator arranged in-between the first and second optical element.

6. The communication system according to claim 1, comprising:
an electro-optical transceiver generating a plurality of optical signals to be propagated in point-to-multipoint transmission to two converter modules.

7. A converter module for a power electronic converter with a plurality of converter modules individually mountable in a converter cabinet, the converter module comprising:
a power semiconductor switch;
a communication unit; and
a second optical element that propagates to the communication unit, an optical signal received from a first optical element arranged on a converter cabinet, the optical signal being propagated across an optically transparent medium,
wherein the optically transparent medium includes a straight optical path between the first optical element and the second optical element.

8. The converter module according to claim 7, wherein the communication unit identifies, among a plurality of optical signals propagated in point-to-multipoint transmission, an optical signal directed to the semiconductor switch.
